(19) United States
(12) Patent Application Publication
(10) Pub. No.: US 2024/0357050 A1
(43) Pub. Date: Oct. 24, 2024

(54) DEVICE, METHOD AND PROGRAM FOR COMBINING VIDEO SIGNALS

(71) Applicant: NIPPON TELEGRAPH AND TELEPHONE CORPORATION, Tokyo (JP)

(72) Inventors: Toshihito FUJIWARA, Musashino-shi, Tokyo (JP); Tatsuya FUKUI, Musashino-shi, Tokyo (JP); Ryota SHIINA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/579,819

(22) PCT Filed: Aug. 6, 2021
(86) PCT No.: PCT/JP2021/029431

§ 371 Date: Jan. 16, 2024

(51) Int. Cl. H04N 5/067; G09G 5/377

(52) U.S. Cl. CPC H04N 5/0675; G09G 5/377; G09G 2340/10

(57) ABSTRACT

An object of the present disclosure is to reduce a delay time until a specific video input is output at the time of inputting a plurality of asynchronous video images and synthesizing the images.

The present disclosure is an apparatus for synthesizing a plurality of asynchronously input video signals into a video signal displayed on one screen, wherein the plurality of video signals are synthesized such that a delay of a video signal of a pivot input set among the plurality of video signals is reduced.

### TECHNICAL FIELD

The present invention relates to a video synthesis technique for synthesizing one screen from a plurality of video input signals and outputting the screen.

### BACKGROUND ART

In recent years, many video devices have been used. Various numbers of pixels (resolution), frame rates, and the like are used for video images of the many video devices. The video signals of such video devices are for transmission of one screen using the time of 1/frame rate thereof, although there are differences in physical signals, control signals, and the like in accordance with standards. For example, if a video signal is 60 frames per second, a video image of one screen is transmitted for 1/60 seconds, that is, about 16.8 milliseconds (hereinafter, 60 fps (frame per second)).

These video utilization methods include a form such as a video conference in which a plurality of cameras are displayed on a number of monitors which is fewer than the number of cameras. In this case, for example, screen synthesis is performed in such a manner that a plurality of video images are displayed separated from each other on one screen, or one video screen is displayed by being reduced in size and inserted into another video.

In general, since the timings of video signals are not synchronized and the timing of another video signal which is being synthesized may be different, the signals are temporarily buffered in a memory or the like and then synthesized. As a result, a delay occurs in the output of a composite screen.

When it is assumed that an ensemble or the like at a remote place or the like is performing in a video conference in which such screen synthesis is performed, a delay related to the synthesis greatly impairs the realization thereof. For example, in the case of music having 120 beats per second (hereinafter, 120 BPM (Beat Per Minute)), the time corresponding to one beat is 60/120 seconds=500 milliseconds. If it is necessary to match this with a precision of 5%, it is necessary to curb the delay until a video image is captured and displayed by a camera at 500×0.05=25 milliseconds or less.

In fact, before capturing and displaying by the camera, other delays, such as an image processing time in the camera, a display time in a monitor, and a time related to transmission need to be considered in addition to processing related to synthesis. As a result, in the prior art, it is difficult to perform cooperative work in applications in which timing is important such as ensemble performances or the like in which video images are viewed from a remote places.

In addition, in an ensemble or the like in which an instructor who instructs timing, tempo, and articulation, such as a conductor, is present, a low delay is required in video images of the instructor, in particular.

Therefore, it is necessary to provide a system that synthesizes a plurality of screens from a plurality of sites, or the like, and that reduces a delay in the time from video input of asynchronous video images until output of a synthesized video image thereof for cooperative work that requires low delay. In particular, it is necessary to provide a system for minimizing a delay in the time required to output a synthesized video image of specific video input.

### CITATION LIST

### Non Patent Literature

[NPL 1] VESA and Industry Standards and Guidelines for Computer Display Monitor Timing (DMT), Version 1.0, Rev. 13, Feb. 8, 2013

### SUMMARY OF INVENTION

### Technical Problem

An object of the present disclosure is to reduce a delay time until a specific video input is output at the time of inputting a plurality of asynchronous video images and synthesizing the images.

### Solution to Problem

An apparatus and a method of the present disclosure include an apparatus for synthesizing a plurality of asynchronously input video signals into a video signal displayed on one screen,
wherein the plurality of video signals are synthesized such that a delay of a video signal of a pivot input set among the plurality of video signals is reduced.

A program of the present disclosure is a program for causing a computer to be realized as each functional unit included in the apparatus according to the present disclosure and a program for causing a computer to execute each step included in a method performed by the apparatus according to the present disclosure.

### Advantageous Effects of Invention

According to the present disclosure, it is possible to reduce a delay time until a specific video input is output at the time of inputting a plurality of asynchronous video images and synthesizing an image thereof.

### BRIEF DESCRIPTION OF DRAWINGS

FIG. 1 shows an example of information of a screen included in a video signal.

FIG. 2 shows an example of a system configuration of the present disclosure.

FIG. 3 shows an example of synthesizing one output frame from four input frames.

FIG. 4 shows an example of a sub-screen group.

FIG. 5 shows an example of a video synthesis method of the present disclosure.

FIG. 6 shows an example of a video synthesis method of the present disclosure.

FIG. 7 shows a configuration example of a video synthesis apparatus.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

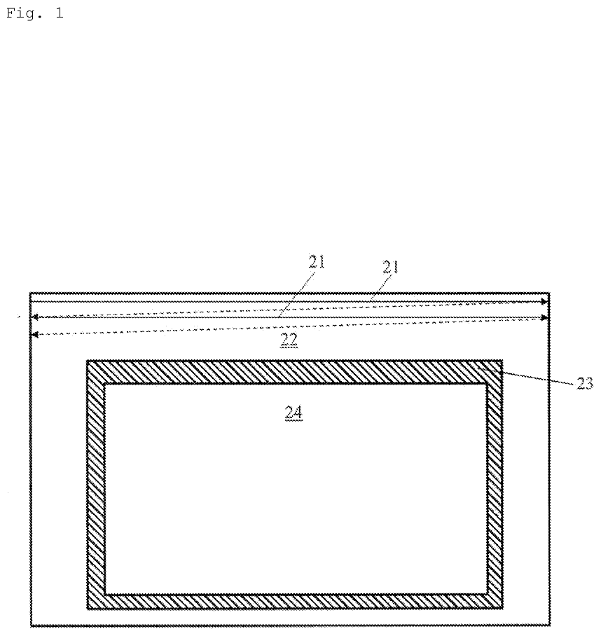

FIG. 1 shows an example of information of a screen included in a video signal. The information of the screen is transmitted by scanning the screen for each scanning line 21 in the lateral direction and sequentially scanning lower scanning lines 21. This scanning includes overhead information/signals such as a blanking portion 22 and a border portion 23 in addition to a display screen 24. The blanking portion 22 may include information other than video information, such as control information and audio information.

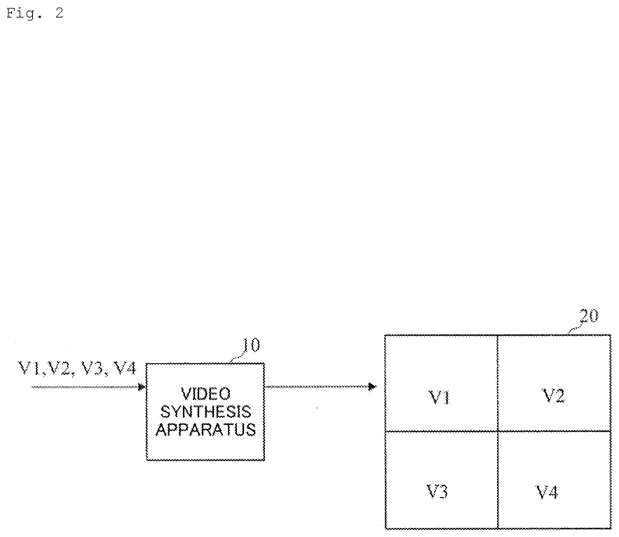

FIG. 2 shows an example of a system configuration of the present disclosure. In the present disclosure, as an example, an example in which four video signals V1 to V4 are input to a video synthesis apparatus 10, and the video synthesis apparatus 10 synthesizes the video signals into a video signal displayed on one screen 20 and outputs the synthesized video signals is shown. In the case of a video signal, one screen is transmitted using a time corresponding to 1/frame rate thereof. For example, if a video signal is 60 frames per second, the video signal of one screen is transmitted for 1/60 seconds, that is, about 16.7 milliseconds (hereinafter, 60 fps (Frame per Second)). Information of one screen at each point in time included in a video signal is referred to as a “frame,” information of one screen of each video signal input to the video synthesis apparatus 10 is referred to as an “input frame,” and information of one synthesized screen output from the video synthesis apparatus 10 is referred to as an “output frame.”

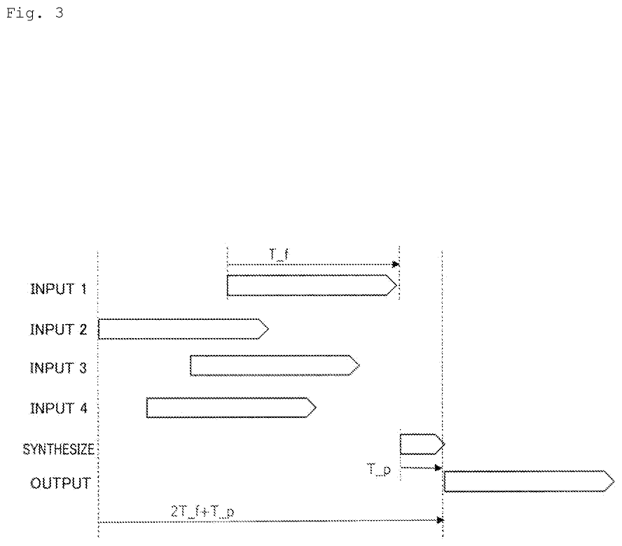

FIG. 3 shows an example in which four video images at different timings are input, synthesized into one screen, and output. A case in which the video synthesis apparatus 10 reads all input video screens, synthesizes them, and outputs a synthesized video screen is conceived. In this case, when a frame time is set to T_f and a synthesis processing time is set to T_p, an output frame is delayed by 2T_f+T_p at the maximum from the point in time of input of the first input frame. For example, if a video image of 60 fps is assumed, a delay of more than a time corresponding to 2 frames, that is, 33.3 milliseconds or more, is likely to be included in the synthesized video image.

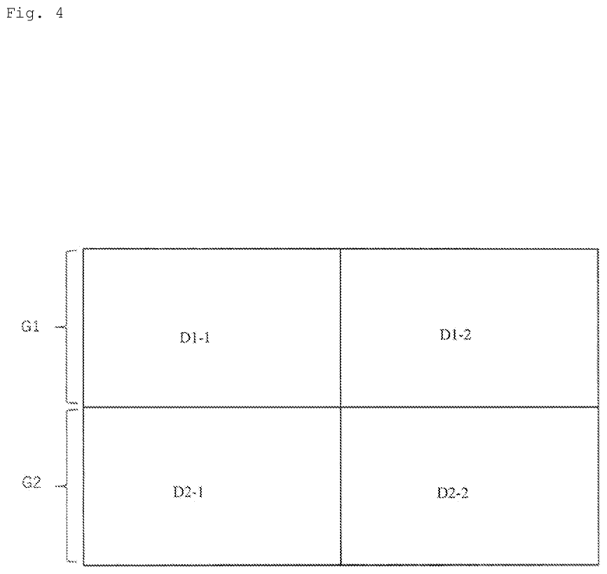

In the present disclosure, screens disposed on the same scanning line in the lateral direction among divided screens are defined as one group and this group is referred to as a “sub-screen group.” For example, when the video synthesis apparatus 10 synthesizes four video signals of inputs 1 to 4,sub-screens D1-1 and D1-2 disposed in the lateral direction are defined as a sub-screen group G1, and sub-screens D2-1 and D2-2 disposed in the lateral direction are defined as a sub-screen group G2, as shown in FIG. 4. That is, output frame data is output first from the sub-screen group G1 disposed above, and then the sub-screen group G2 is output.

Further, in the present disclosure, an input (hereinafter, referred to as “pivot input”) that needs to have a shortest delay from input to output is set. The present disclosure relates to a system for receiving a plurality of asynchronous video images as inputs and synthesizing the video images, in which screen layout and output timing are optimized based on this pivot input.

In the present disclosure, it is possible to sequentially output data to an output frame without waiting for completion of input of an input frame. That is, excluding an overhead, a delay from input to output can be minimized when completion of input of an input frame coincides with completion of output of a screen of a sub-group to which the input belongs.

Specifically, in the present disclosure, a sub-screen group of the pivot input is selected such that a delay until the pivot input is output is low. Although sub-images in the same sub-screen group from which the pivot input is output are arbitrary, the present disclosure shows an example in which the pivot input is disposed such that an input timing becomes the latest timing.

After determining a sub-screen group that is an output destination of the pivot input, sub-screen groups of inputs other than the pivot input are selected. At this time, assignment of sub-screen groups and a frame order of inputs are selected such that an average delay until output and a maximum delay are minimized with respect to the inputs other than the pivot input.

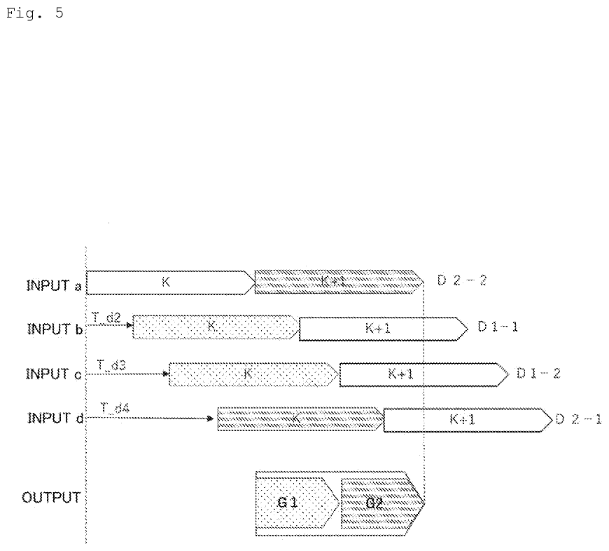

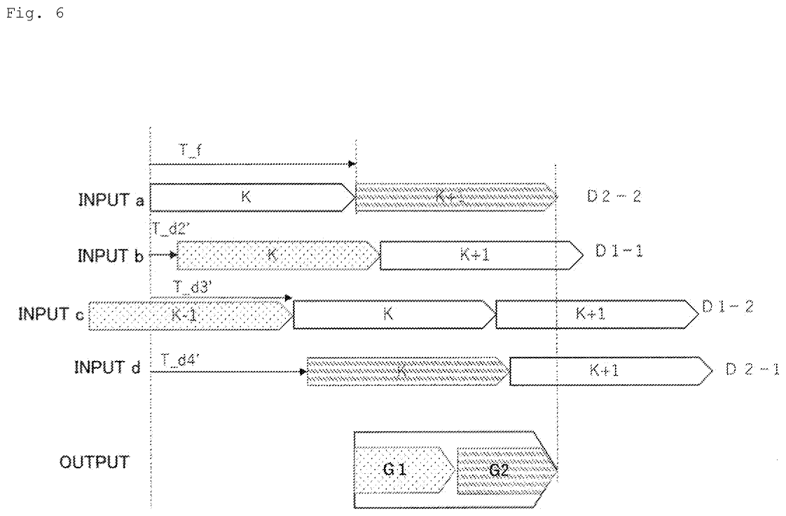

Hereinafter, an example in which input a is a pivot input, a composite screen is divided into four, the upper two sub-screens D1-1 and D1-2 are defined as a sub-screen group G1, and the lower two sub-screens D2-1 and D2-2 are defined as a sub-screen group G2 will be described with reference to FIG. 5 and FIG. 6.

For example, when the input a that is the pivot input is output to the sub-screen group G2 and the output is made the shortest, the sub-screen group G2 is synthesized and output such that output of the sub-screen group G2 is completed when input of the input a is completed when processing overhead is removed. For example, the sub-screen group G2 is output such that the output matches completion of input of the K+1 frame of the input a.

In the inputs b, c and d other than the input a to the sub-screen group G2, frames which have been input earlier than the K+1 frame of the input a are selected. In the examples shown in FIG. 5 and FIG. 6, a frame before K of the input b, a frame before K of the input c, and a frame before K of the input d can be selected.

Here, as an input of sub-screen groups other than the sub-screen group to which the pivot input belongs, an input and an input frame which are in time to output of a sub-screen group to be output are selected on the basis of the timing at which the sub-screen group G2 to which the pivot input belongs can be output with a minimum delay.

For example, the K frame of the input d having a minimum input delay difference from the K+1 of the input a can be selected as the sub-screen group G2. In this case, inputs b and c are input to the sub-screen group G1. In FIG. 5, the K-th frame can be selected for the input to the sub-screen group G1. On the other hand, in FIG. 6, input of the K frame of the input c is completed after completion of output of the sub-screen group G1. In such a case, the video synthesis apparatus 10 selects the input c of the K-1 frame and outputs the sub-screen group G1.

Although FIG. 5 and FIG. 6 show examples of a case in which the input a is set as a pivot input and the pivot input is output to the sub-screen group G2, the present disclosure is not limited thereto. When the input a is set as a pivot input and the pivot input is output to the sub-screen group G2, a combination for minimizing the average delay and the maximum delay of the inputs b, c, and d may be selected in setting of sub-screens of the inputs b, c, and d. For example, a combination for minimizing a delay in an input which needs to be minimized following the pivot input can be selected.

The sub-screen group that outputs the pivot input is not limited to the sub-screen group G2 displayed at the bottom of the screen, and the sub-screen group G1 can also output the pivot input. A selectable sub-screen group for each input including the pivot input, including the sub-screen that outputs the pivot input, and all frames thereof can be evaluated, and set as output of a combination for minimizing the average delay or maximum delay until each input is output.

For example, the video synthesis apparatus 10 compares the average delay of all the inputs a to d when output of the pivot input is set to the sub-screen group G2 with the average delay of all the inputs a to d when output of the pivot input is set to the sub-screen group G1, and if the average delay of all the inputs a to d is smaller when output of the pivot input is set to the sub-screen group G1, sets output of the pivot input to the sub-screen group G1.

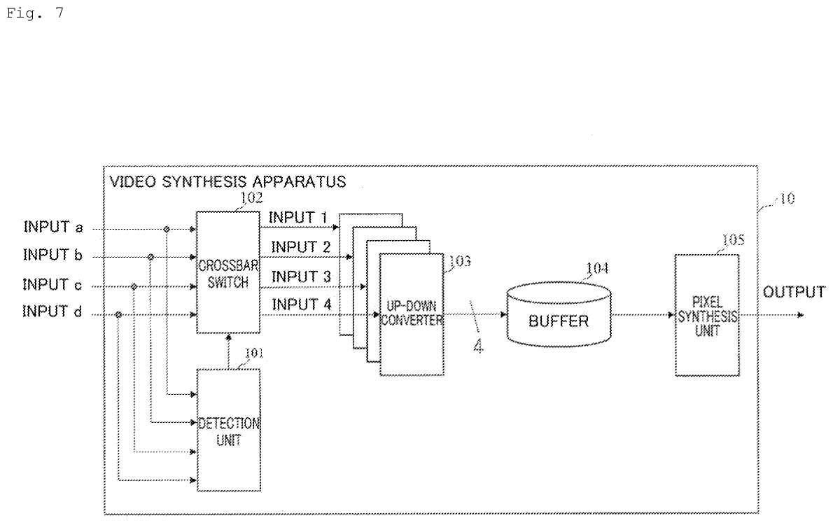

FIG. 7 shows a configuration example of the video synthesis apparatus 10 according to the present embodiment. The video synthesis apparatus 10 according to the present embodiment includes a detection unit 101, a crossbar switch 102, an up-down converter 103, a buffer 104, and a pixel synthesis unit 105. Although the figure shows four inputs and one output, an arbitrary number N of inputs and outputs may be used. Further, a screen may not be equally divided.

101 denotes a functional unit of detecting an input order within a frame time for N inputs.

102 denotes a crossbar switch, which is a function of rearranging and outputting inputs according to the input order detection result order from 101.

103 denotes an up-down converter that increases or decreases the number of pixels to an arbitrary size.

102 and 103 may be connected in reverse to inputs (a, b, c, d, . . . ). That is, 103 performs increase/decrease from the input a, b, c, and d, and then 102 may rearrange and output inputs in the input order.

104 denotes a buffer. It can buffer inputs of 103 or 102 and output the inputs in an arbitrary order.

105 denotes a pixel synthesis unit. From the entire screen to be output, pixel data is read from 104 in an output order, synthesized, and output. The sub-screen to be synthesized and output is described above. 105 may add an arbitrary control signal to a blanking portion of the screen.

The video synthesis apparatus 10 according to the present disclosure can also be realized by a computer and a program, and the program can be recorded in a recording medium or can also be provided via a network.

A pivot input can be arbitrarily set, for example, set by an external instruction or set on the basis of information included in a video signal. For example, it may be set on the basis of a flag indicating a priority included in the video signal or may be set on the basis of results of image processing. For example, a conductor is determined according to image processing, and a video image in which the conductor is projected with a large size is set as a pivot input. Further, an object such as a person who is rapidly moving may be determined according to image processing, and a video image in which the object which is rapidly moving is projected is set as a pivot input.

The pivot input can be switched at any timing. For example, when an object which is rapidly moving has been changed according to image processing, the pivot input is switched to a new object which is rapidly moving. Accordingly, it is possible to adjust an output in accordance with an input whose delay needs to be minimized.

### Advantageous Effects of Present Disclosure

The present disclosure can reduce a delay time until output after synthesis with respect to an input while minimizing a delay time until output after synthesis with respect to another input. Accordingly, cooperative work with strict low-delay requirements, in particular, stricter low-delay requirements for a specific input can be performed through a system for synthesizing a plurality of screens of a plurality of sites or the like.

### Points of Present Disclosure

In a system that synthesizes and displays video images of a plurality of sites, a low delay in synthesis processing up to output for one input is most required for cooperative work with strict low-delay requirements such as ensembles and conditions in which low-delay requirements are particularly strict, such as conductors, and a low delay in synthesis processing is also required for other inputs.

The present disclosure relates to a system that receives a plurality of asynchronous video images as inputs and synthesizes the images, and can reduce a delay time until output after synthesis by disposing a pivot input in the same sub-screen group such that an input timing is the latest timing. Accordingly, cooperative work requiring strict low delay requirements can be performed through a system for synthesizing a plurality of screens of a plurality of bases or the like.

### INDUSTRIAL APPLICABILITY

The present disclosure is applicable to information and communication industries.

### REFERENCE SIGNS LIST

10: Video synthesis apparatus
20: Screen
21: Scanning line
22: Blanking portion
23: Border portion
24: Display screen
101: Detection unit
102: Crossbar switch
103: Up-down converter
104: Buffer
105: Pixel synthesis unit

1. An apparatus for synthesizing a plurality of asynchronously input video signals into a video signal displayed on one screen, wherein the plurality of video signals are synthesized such that a delay of a video signal of a pivot input set among the plurality of video signals is reduced.

2. The apparatus according to claim 1, wherein video signals other than the pivot input, which are synthesized with the video signal of the pivot input, are video signals that have been input before the pivot input.

3. The apparatus according to claim 1, wherein video signals included in the plurality of video signals are output for each sub-screen group constituting a part of the one screen, and the video signal of the pivot input is output to a sub-screen group that allows a delay of the pivot input to be reduced.

4. The apparatus according to claim 3, wherein the sub-screen group is a set of sub-screens disposed on the same scanning line of the screen.

5. The apparatus according to claim 1, wherein a sub-screen for which the plurality of video signals are output is determined such that delays of the plurality of video signals are minimized.

6. A method of synthesizing a plurality of asynchronously input video signals into a video signal displayed on one screen, wherein the plurality of video signals are synthesized such that a delay of a video signal of a pivot input set among the plurality of video signals is reduced.

7. A non-transitory computer-readable medium having computer-executable instructions that, upon execution of the instructions by a processor of a computer, cause the computer to function as the apparatus according to claim 1.
